(19) United States
(12) Patent Application Publication
(10) Pub. No.: US 2024/0412245 A1
(43) Pub. Date: Dec. 12, 2024

(54) Marijuana Excise Tax Data Management and Loyalty Systems

(71) Applicant: Samuel Kenyatta Giles, Denver, CO (US)

(72) Inventor: Samuel Kenyatta Giles, Denver, CO (US)

(73) Assignee: CB1 Logistics, Ltd., Denver, CO (US)

(21) Appl. No.: 18/737,999

(22) Filed: Jun. 8, 2024

Related U.S. Application Data
(60) Provisional application No. 63/506,835, filed on Jun. 8, 2023.

(51) Int. Cl. G06Q 30/0226

(52) U.S. Cl. CPC G06Q 30/0232; G06Q 2220/00

(57) ABSTRACT

This patent application discloses innovative methods for a digitized loyalty and rewards network within the regulated marijuana industry. A unique business model allows an excise tax exempt, social equity designated marijuana retailer to leverage its excise tax savings, creating digitized currency value at the transfer of wholesale cannabis. This value is partially allocated as digitized currency and transferred to licensed operators and consumers within the regulated marijuana supply chain. Tokens are earned via purchases or specific marketing initiatives, with the digital asset value directly linked to excise tax savings. This approach precludes inadvertent marketing to underage individuals. By encouraging repeat business and rendering excise tax savings tangible, the system promotes symbiotic relationships within the supply chain. The network ensures seamless, efficient, transparent, and secure value transfers, bolstering the integrity and traceability of rewards and fostering a modern, efficient marijuana ecosystem.

### CROSS REFERENCE TO RELATED APPLICATION

This application claims benefit of U.S. Provisional Patent Application No. 63/506,835, filed Jun. 8, 2023

### BACKGROUND

### Field of Invention

This invention pertains to the field of loyalty and rewards programs, with specific application to the retail marijuana industry. More precisely, it deals with the innovative use of digitized currency, efficiently applied through blockchain-based digital assets, or cryptocurrency tokens, as a medium for delivering value derived from marijuana excise tax savings throughout a state regulated marijuana supply chain in a loyalty program context.

### Brief History of the War on Drugs

Prior to officially declaring a War on Drugs, President Nixon demonstrated interest in drug control legislation with an emphasis on law enforcement. He also enhanced international drug control efforts and made a successful push to curb opium production in Turkey. In his efforts to enhance federal control of drugs, President Nixon pushed for passage of comprehensive federal drug laws. The Controlled Substances Act (CSA), enacted as Title II of the Comprehensive Drug Abuse Prevention and Control Act of 1970 (P.L. 91-513), placed the control of select plants, drugs, and chemical substances under federal jurisdiction. Congress passed this legislation, in part, to replace previous federal drug laws with a single comprehensive statute. This created the legal foundation for the War on Drugs.

The CSA not only combined existing federal drug laws and expanded their scope, but it also changed the nature of federal drug law policies and expanded federal law enforcement pertaining to controlled substances. Title II, Part F of the CSA established the National Commission on Marijuana and Drug Abuse—known as the Shafer Commission after its chairman, Raymond P. Shafer—to study cannabis abuse in the United States. During his presentation of the commission's First Report to Congress, Sonnenreich and Shafer recommended the decriminalization of marijuana in small amounts, with Shafer stating, “[T]he criminal law is too harsh a tool to apply to personal possession even in the effort to discourage use. It implies an overwhelming indictment of the behavior which we believe is not appropriate. The actual and potential harm of use of the drug is not great enough to justify intrusion by the criminal law into private behavior, a step which our society takes only with the greatest reluctance.”

In June 1971, President Nixon ignored the report, rejected its recommendations, and officially declared a “war on drugs” on the citizens of the United States. He dramatically increased the size and presence of federal drug control agencies and pushed through measures such as mandatory sentencing and no-knock warrants.

A top Nixon aide, John Ehrlichman, later admitted: “You want to know what this was really all about. The Nixon campaign in 1968, and the Nixon White House after that, had two enemies: the antiwar left and black people. You understand what I'm saying. We knew we couldn't make it illegal to be either against the war or black, but by getting the public to associate the hippies with marijuana and blacks with heroin, and then criminalizing both heavily, we could disrupt those communities. We could arrest their leaders, raid their homes, break up their meetings, and vilify them night after night on the evening news. Did we know we were lying about the drugs? Of course we did.”

Marijuana was classified as within Schedule One, the most restrictive category of drugs.

### Development of Social Equity Designation

The racial disparities reveal the drug war's inherent unconstitutionality. Following the passage of stiffer penalties for crack cocaine, marijuana and other drugs, the Black incarceration rate in America exploded from about 600 per 100,000 people in 1970 to 1,808 in 2000. In the same time span, the rate for the Latino population grew from 208 per 100,000 people to 615, while the white incarceration rate grew from 103 per 100,000 people to 242.

To counter this injustice, many states and cities have implemented social equity programs in connection with the legalization of medical or adult-use cannabis. Social equity deals with justice and fairness within cannabis social policy. These programs attempt to ensure that the populations targeted under the War on Drugs, and those with marijuana offenses prior to legalization, be afforded an opportunity to participate, meaningfully, in this burgeoning industry.

### History of the Accelerator Store

The first regulated cannabis states, including Colorado, have only recently taken action on this front. In 2020, Colorado House Bill 20-1424, entitled, “Social Equity in Regulated Cannabis Businesses” defined social equity candidates, created the accelerator store license type, and was amended to add the ability for the governor to pardon cannabis crimes to expunge criminal records and enable more people who were harmed by the War on Drugs. Furthermore, the was designed without a fiscal note, indicating the lawmaker's intent for the accelerator store license type to not have a fiscal impact on the state budget, via tax or appropriations.

### Legal Apparatus for Accelerator Store Excise Tax Exemption

This provisional patent application demonstrates that the state designated social equity retailer, entitled an Accelerator Store, under section 44-10-611 (1), of the Colorado Revised Statute, is exempt from tax imposition under the Colorado Constitution Article XVIII, Section 16 (2)(n). The Accelerator Store license is a separate license from a retail marijuana store, and the definition of an Accelerator Store is not sufficient to interpret this new license type as a “retail marijuana store.” Consequently, the retail marijuana excise tax in subsection 39-28.8-302(1)(a)(I), C.R.S., is not imposed when retail marijuana is transferred from a state licensed cultivation facility to an Accelerator Store. Tax imposition statutes, such as 39-28.8-302, C.R.S., must be construed narrowly and in the taxpayer's favor. Additionally, this provisional patent application will discuss various embodiments that can be deployed due to the value captured by the aforementioned innovation.

### Constitutional & Statutory Framework

The Colorado Constitution Article XVIII, Section 16 (2)(n), defines a retail marijuana store as “an entity licensed to purchase marijuana from marijuana cultivation facilities and marijuana and marijuana products from marijuana product manufacturing facilities and to sell marijuana and marijuana products to consumers.” However, the definition of an Accelerator Store under section 44-10-103 (4.5), C.R.S., is not sufficient to interpret this new license type as a “retail marijuana store.” The Accelerator Store license is a separate license from a retail marijuana store and is defined as “a social equity licensee qualified to participate in the accelerator program established pursuant to this article 10 and authorized pursuant to rule to exercise the privileges of a retail marijuana store on the premises of an accelerator-endorsed retail marijuana store licensee.”

Furthermore, the Colorado Constitution requires that “The general assembly shall enact an excise tax to be levied upon marijuana sold or otherwise transferred by a retail marijuana cultivation facility to a marijuana product manufacturing facility or to a retail marijuana store at a rate not to exceed fifteen percent” (See Colo. Const. Art. XVIII, Section 16, (5)(d)). The Constitution does not enumerate the Accelerator Store license as a target of the excise tax imposition. Therefore, if an Accelerator Store is not a “retail marijuana store,” the retail marijuana excise tax in subsection 39-28.8-302(1)(a)(I), C.R.S., is not imposed when retail marijuana is transferred from a cultivation facility to an Accelerator Store.

The Tax Code, section 39-28.8-202 (1)(a)(I), C.R.S., which imposes the retail marijuana sales tax, uses broader language saying, “there is imposed upon all sales of retail marijuana by a retailer a tax . . . ” (emphasis added). But that section also later refers specifically to retail marijuana stores making its application potentially ambiguous. Consequently, tax imposition statutes, such as 39-28.8-302, C.R.S., must be construed narrowly and in the taxpayer's favor.

Therefore, the Accelerator Store license type provides unique opportunities for tax savings, which can be leveraged to create various business models. One potential business model is an embedded partnership between the sponsoring Retail Marijuana Store and the hosted Accelerator Store as developed in the state of Colorado's accelerator program, the state's social equity initiative. (See 44-10-103, et seq, C.R.S.) This arrangement allows for an “Equity Partnership Agreement” (See 1 Colo. Code Regs. § 212-3-3-1105(D)), between the sponsoring Retail Marijuana Store and the hosted Accelerator Store. Marijuana excise tax savings realized by the Accelerator Store can be distributed throughout the marijuana supply chain, including the sponsoring Retail Marijuana Store. In kind, the sponsoring Retail Marijuana Store can provides technical, compliance, and/or capital assistance in exchange for excise tax savings. See 1 Colo. Code Regs. § 212-3-3-1105(D)

### DESCRIPTION OF RELATED ART

Conventional loyalty schemes in retail, including marijuana, have largely underperformed in nurturing enduring customer loyalty. Their simplistic point systems, offering rewards devoid of intrinsic value, are constricted to specific outlets and subject to retailer whim. These drawbacks, compounded by program complexity and opacity, impede customer engagement.

Regarding related marijuana, the inconsistency in cannabis marketing regulations adds to these challenges. While most U.S. states do not address key aspects of cannabis advertising that are banned in Canada, among those that do, the focus is on avoiding youth targeting and misleading claims. Nevertheless, the lack of consistent guidelines may lead to inadvertent exposure of vulnerable populations to cannabis ads. Given this gap in federal oversight, the present innovation is a pioneering solution to prevent unintentional cannabis marketing to underage demographics.

Cannabis companies face difficulties in delivering appropriate messages to their target audiences. Their limited budgets are largely expended on broad spectrum brand awareness rather than targeted consumer marketing. Furthermore, these companies struggle to effectively leverage potent marketing channels and to adequately track key performance indicators. Advertising restrictions on cannabis and related brands, along with covert deals skewing competition, are also problematic for the majority of industry executives.

The marijuana retail sector faces another hurdle, the burden of significant excise taxes. Traditional business models and loyalty programs fail to pass these tax savings to consumers, impacting affordability and accessibility for many.

By integrating cryptocurrency into loyalty programs, these issues will be mitigated. Cryptocurrency tokens, possessing real value and exchangeable both within and beyond the retail ecosystem, bring flexibility. Tying their value to real-world metrics, like excise tax savings, makes the rewards tangible and meaningful. Blockchain technology ensures transaction transparency, traceability, and security, fostering trust and engagement.

The present invention is a distinctive loyalty program for the retail marijuana industry that addresses these issues, allocating cryptocurrency tokens representing excise tax savings as rewards. It transfers value throughout the supply chain, enhances customer engagement, shares tax savings with consumers, and ultimately fosters a more equitable and sustainable retail marijuana industry.

### DESCRIPTION OF THE INVENTION

Given the classification of cannabis as a prohibited substance under federal law, financial institutions have been wary of providing services to the industry. The reasons for this hesitance stem from both reputational concerns and fears of legal repercussions. As a result, the industry has become cash-driven, posing challenges for accurate taxation and regulation. The present invention offers a solution to these issues by equipping social equity designated retailers with an immutable record of every transaction.

Increased cash reliance results in less transparency, a higher risk of money laundering, tax avoidance, and fraud. As cash flows rise in this industry, it becomes more difficult to regulate and avoid illicit activity. Furthermore, almost 90% of cannabis business executives believe that back-channel deals are an issue.

The present invention disrupts the existing loyalty program model by employing a cryptocurrency-based system rooted in state authorized excise tax savings for social equity retailers within the marijuana industry, offering solutions to these problems. Unlike competing solutions, this proprietary framework uses a unique digital token technology tied to marijuana excise tax savings, providing a more viable alternative to cash transactions and enhancing bookkeeping and regulatory oversight.

The present invention loyalty system aims to address the challenges facing social equity operators in the regulated marijuana industry. By creating and distributing digitized currency, the present invention provides a stable transactional cryptocurrency and a platform for consumers to participate in this burgeoning industry.

Competing cryptocurrency solutions suffer from two main flaws: non-compliance with state securities laws, and lack of ties to marijuana excise tax imposition. The former makes it difficult, if not impossible, to facilitate transactions within the U.S. legal cannabis industry, while the latter limits the currency's transactional appeal.

The loyalty program of the present invention, operating on a blockchain platform, assures security, privacy, and removes the need for centralized authority. Social equity designated retailers, referred to as Accelerator Stores, manage the “Loyalty Tokens”, recording every transaction from the transfer of wholesale cannabis that results in excise tax savings, converting this added value into Loyalty Tokens at a predetermined exchange rate.

Imagine a licensed cannabis cultivation facility selling wholesale cannabis to an Accelerator Store, which results in state authorized tax savings. The present invention verifies the parties' status, logs the transactions on the blockchain, calculates the tax saved, and issues Loyalty Tokens of equivalent value to participants. These Loyalty Tokens can be distributed to customers, functioning much like traditional rewards points.

The present invention integrates an API that facilitates real-time communication between the blockchain and a marijuana retailer's POS systems, making Loyalty Tokens instantly available. Compatibility with mobile wallets and cryptographic security measures ensures safe storage and transfer of tokens. Additionally, the use of a smart contract enables instant transfer of Loyalty Tokens throughout the supply chain.

This novel platform leverages the benefits of digital currency and blockchain technologies to enhance customer loyalty, ensure regulatory oversight, and efficiently pass on tax savings in the retail marijuana industry. It fosters a broader adoption of blockchain technology in the retail sector, adding value to the entire marijuana supply chain.

These features, along with many others, are discussed in greater detail below.

### BRIEF SUMMARY

Embodiments of the present disclosure may include a marijuana excise tax data management node in a blockchain network including a blockchain, a data provider (DP) node, and a service provider (SP) node, the marijuana excise tax management node may be a computing device including a memory storing one or more instructions. Embodiments may also include a hardware processor that when executing the one or more instructions may be configured to generate a profile token modelling a data profile of the DP node and including a commitment to an address of the DP node.

Embodiments may also include a data field of the DP node. Embodiments may also include a symmetric key of the DP node. Embodiments may also include generate a loyalty token modelling a data profile of the DP node and including a commitment to an excise tax data field of the DP node. Embodiments may also include an address of the DP node.

Embodiments may also include a data field of the DP node. Embodiments may also include a symmetric key of the DP node. Embodiments may also include receive a transaction request from the SP node to access data from the DP node via the blockchain, the blockchain network uses one or more smart contracts to manage transactions for multiple participating nodes.

Embodiments may also include acquire consent of the SP node based on the profile token. Embodiments may also include acquire consent of the SP node based on the loyalty token. Embodiments may also include generate a consent token based the consent of the SP node. Embodiments may also include allow the SP node to access the data of the DP node via the blockchain based on a zero-knowledge proof verification of the consent token.

In some embodiments, the processor may be further configured to maintain a verifiable record of consent for the SP node to access the data from the DP node. In some embodiments, the processor may be further configured to execute the requested transaction if the verifiable record of the consent exists on the blockchain. In some embodiments, the verifiable record of the consent may be based on the zero-knowledge proof.

In some embodiments, the processor may be further configured to revoke the verifiable record of the consent on the blockchain. In some embodiments, identities of consented parties may be not discoverable from the verifiable record of the consent. In some embodiments, the processor may be further configured to allow access to the data of the DP node by the SP node. In some embodiments, an identity of the DP node may be not discoverable. In some embodiments, the processor may be further configured to verify the consent token in a distributed manner based on consensus protocols.

Embodiments of the present disclosure may also include a method, including generating, by a marijuana excise tax data management node which may be a computing device in a blockchain network including a blockchain, a data provider (DP) node, and a service provider (SP) node, a loyalty token based on a data profile of the DP node, the loyalty token modelling a data profile of the DP node, a profile token based on a data profile of the DP node, the profile token modelling a data profile of the DP node and including a commitment to an address of the DP node.

Embodiments may also include a data field of the DP node. Embodiments may also include a symmetric key of the DP node. Embodiments may also include receiving, by the data management node, a transaction request from the SP node to access data from the DP node via the blockchain, the blockchain network uses one or more smart contracts to manage transactions for multiple participating nodes.

Embodiments may also include acquiring, by the marijuana excise tax data management node, consent of the SP node based on the profile token. Embodiments may also include acquiring, by the marijuana excise tax data management node, consent of the SP node based on the loyalty token. Embodiments may also include generating, by the marijuana excise tax data management node, a consent token based the consent of the SP node. Embodiments may also include allowing, by the data management node, the SP node to access the data of the DP node via the blockchain based on a zero-knowledge proof verification of the consent token.

In some embodiments, the method may include maintaining a verifiable record of consent for the SP node to access the data from the DP node. In some embodiments, the method may include executing the requested transaction if the verifiable record of the consent exists on the blockchain. In some embodiments, the verifiable record of the consent may be based on the zero-knowledge proof.

In some embodiments, the method may include revoking the verifiable record of the consent on the blockchain. In some embodiments, identities of consented parties may be not discoverable from the verifiable record of the consent. In some embodiments, the method may include allowing access to the data from the DP node by the SP node. In some embodiments, an identity of the DP node may be not discoverable. In some embodiments, the method may include verifying the consent token in a distributed manner based on consensus protocols.

Embodiments of the present disclosure may also include a non-transitory computer readable medium including one or more instructions that when executed by a hardware processor of a marijuana excise tax data management node which may be a computing device in a blockchain network including a blockchain, a data provider (DP) node, and a service provider (SP) node, cause the processor to perform generating a profile token based on a data profile of the DP node, the profile token modelling a data profile of the DP node and including a commitment to an address of the DP node.

Embodiments may also include a data field of the DP node. Embodiments may also include a symmetric key of the DP node. Embodiments may also include generate a loyalty token modelling a data profile of the DP node and including a commitment to an excise tax data field of the DP node. Embodiments may also include an address of the DP node.

Embodiments may also include a data field of the DP node. Embodiments may also include a symmetric key of the DP node. Embodiments may also include receiving a transaction request from the SP node to access data from the DP node via the blockchain, the blockchain network uses one or more smart contracts to manage transactions for multiple participating nodes.

Embodiments may also include acquiring consent of the SP node based on the loyalty token. Embodiments may also include generating a consent token based the consent of the SP node. Embodiments may also include allowing the SP node to access the data of the DP node via the blockchain based on a zero-knowledge proof verification of the consent token.

Embodiments may also include acquiring consent of the SP node based on the profile token. Embodiments may also include generating a consent token based the consent of the SP node. Embodiments may also include allowing the SP node to access the data of the DP node via the blockchain based on a zero-knowledge proof verification of the consent token.

In some embodiments, the one or more instructions further cause the processor to perform maintaining a verifiable record of consent for the SP node to access the data from the DP node. In some embodiments, the one or more instructions further cause the processor to perform executing the requested transaction if the verifiable record of the consent exists on the blockchain.

In some embodiments, the verifiable record of the consent may be based on the zero-knowledge proof. In some embodiments, the one or more instructions further cause the processor to perform revoking the verifiable record of the consent on the blockchain. In some embodiments, identities of consented parties may be not discoverable from the verifiable record of the consent. In some embodiments, the one or more instructions further cause the processor to perform allowing access to the data from the DP node by the SP node. In some embodiments, an identity of the DP node may be not discoverable.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of this disclosure relate to a system for providing a cryptographically secure transaction network for a governmental marijuana regulatory system, the system comprising: at least one user device and a loyalty token server for a digitized currency in network communication with a blockchain-based securities token platform; a blockchain transaction network connected to a governmental regulatory system, the blockchain transaction network operating on the blockchain-based digital token platform; a distributed database or ledger operating on the blockchain transaction network; and a cryptographically secure digitized token used as a medium of exchange for the one or more transactions between the social equity designated marijuana retailer and the one or more participants.

The distributed database or blockchain ledger may update in real-time with the governmental regulatory system. The blockchain transaction network may post and validate one or more transactions between the social equity designated operator and one or more participants in a stablecoin ecosystem on the distributed blockchain ledger. The one or more participants in the loyalty token ecosystem may comprise one or more of the following: producers, processors, consumers, financial agents, regulatory agents, or tax agents. The one or more transactions may include transferring the security-backed loyalty token for a product.

The marijuana excise tax backed digitized currency may be one authorized by a state securities commissioner, for example under the Colorado Digital Token Act, or an SEC-registered security and one of a debt or an equity. The distributed blockchain ledger is cryptographically secured. The governmental regulatory system may be one or more of the following: a state regulatory system, or a municipal regulatory system. The marijuana excise tax backed digitized currency platform and the distributed blockchain ledger may provide transactional information for the one or more transactions to the governmental regulatory system for a history of the product through sourcing, processing, selling, and pricing of cannabis product.

Additional aspects of this disclosure may relate to a system for providing a transaction network for converting marijuana excise tax imposition on at least one marijuana product from a taxable entity to a marijuana excise tax exempt transaction within a governmental marijuana regulatory system, the system consisting of, the system comprising: at least one user device and a digitized currency server for a loyalty token entity in network communication with a blockchain-based loyalty token platform; a blockchain transaction network connected to a governmental regulatory system, the blockchain transaction network operating on the blockchain-based loyalty token platform; a database or distributed blockchain ledger operating on the blockchain transaction network, wherein the database or distributed blockchain ledger updates in real-time the governmental regulatory system; and a state authorized digital token used as a medium of exchange for the one or more transactions between the social equity designated marijuana retailer and the one or more participants. The blockchain transaction network may post and validate one or more transactions between the social equity designated marijuana retailer and one or more participants in a digitized currency ecosystem on the distributed blockchain ledger. The one or more participants in the digitized currency ecosystem may comprise one or more of the following: producers, processors, consumers, financial agents, regulatory agents, or tax agents. The one or more transactions include transferring the state authorized digital tokens for licensed marijuana. The blockchain-based loyalty token platform and the distributed blockchain ledger provide transactional information for the one or more transactions to the governmental regulatory system for a history of the retail marijuana product through sourcing, processing, selling, and pricing of the product. The blockchain-based loyalty token platform and the distributed blockchain ledger may automatically collect, organize, and submit one or more transaction reports based on the one or more transactions and the transactional information to the marijuana regulatory system.

Still other aspects of this disclosure may relate to a system for providing a transaction network for converting marijuana excise tax imposition on at least one marijuana product from a taxable entity to a marijuana excise tax exempt transaction within a governmental marijuana regulatory system, the system consisting of: at least one user device and a digitized currency server for a social equity designated marijuana retailer in network communication with a blockchain-based loyalty token platform; a blockchain transaction network connected to a governmental regulatory system, the blockchain transaction network operating on the blockchain-based loyalty token platform; a database or distributed blockchain ledger operating on the blockchain transaction network, wherein the database or distributed blockchain ledger updates in real-time the governmental regulatory system; and a state authorized digital token used as a medium of exchange for the one or more transactions between the social equity designated marijuana retailer and the one or more participants. The blockchain transaction network may post and validate one or more transactions between the social equity designated marijuana retailer and one or more participants in a loyalty token ecosystem on the distributed blockchain ledger. The one or more participants in the loyalty token ecosystem may comprises one or more of the following: producers, processors, consumers, financial agents, regulatory agents, or tax agents. The state authorized digital token may includes one of: registration, qualification, or exemption under the Colorado Digital Token Act, the U.S. Securities Act, the U.S. Exchange Act, or other applicable U.S. securities laws. The one or more transactions include transferring the state authorized digital token for a legal cannabis product from a legal retail marijuana store. The blockchain-based loyalty token platform and the distributed blockchain ledger may provide transactional information for the one or more transactions to the governmental regulatory system for a history of the legal cannabis product through sourcing, processing, selling, and pricing of the legal cannabis product. The blockchain-based loyalty token platform and the distributed blockchain ledger may automatically collect, organize, and submit one or more transaction reports based on the one or more transactions and the transactional information to the governmental regulatory system.

Additional aspects of the present invention may relate to a transaction network for converting marijuana excise tax imposition on at least one marijuana product from a taxable entity to a marijuana excise tax exempt transaction within a governmental marijuana regulatory system, the system consisting of: at least one user device and a digitized currency server for a social equity designated marijuana retail in network communication with a blockchain-based loyalty token platform; a blockchain transaction network connected to a governmental regulatory system, the blockchain transaction network operating on the blockchain-based loyalty token platform; a database or distributed blockchain ledger operating on the blockchain transaction network, wherein the distributed blockchain ledger updates in real-time the governmental regulatory system; and a state authorized digital token used as a medium of exchange for the one or more transactions between the social equity designated marijuana retailer and the one or more participants. The blockchain transaction network may post and validate one or more transactions between the social equity designated marijuana retailer and one or more participants in a crypto cannabis ecosystem on the distributed blockchain ledger. The one or more transactions may be two-party blockchain transactions, comprising an encryption step, a validation step, and a distribution step. During the encryption step, the transaction may be added to the distributed blockchain ledger and encrypted with a digital security code. During the validation step, the digital security code of the transaction may be confirmed and validated. After the transaction is confirmed and validated by several parties, the transaction may exist on the distributed blockchain ledger. During the distribution step, the transaction may be recorded in a public ledger and the transaction is completed. The one or more transactions may include transferring the state authorized digital token for a product. The blockchain-based loyalty token platform and the database or distributed blockchain ledger may provide transactional information for the one or more transactions to the governmental regulatory system for a history of the product through sourcing, processing, selling, and pricing of the product.

Other systems, methods, features and advantages of the embodiments will be, or will become, apparent to one of ordinary skill in the art upon examination of the following figures and detailed description. It is intended that all such additional systems, methods, features and advantages be included within this description and this summary, be within the scope of the embodiments, and be protected by the following disclosure.

### BRIEF DESCRIPTION OF THE DRAWINGS

FIG. 1 is a schematic diagram of an example marijuana excise tax data management node according to one or more aspects described herein.

FIG. 1A is a block diagram illustrating a marijuana excise tax data management node, according to some embodiments of the present disclosure.

FIG. 2 is a schematic diagram of an example crypto cannabis ecosystem to bring together both a decentralized ledger and digitized currency attached to that ledger according to one or more aspects described herein.

FIG. 2A is a flowchart illustrating a method, according to some embodiments of the present disclosure.

FIG. 3 is a graphical depiction of an example blockchain transaction according to one or more aspects described herein FIG. 3A is a flowchart further illustrating the method from FIG. 2, according to some embodiments of the present disclosure.

FIG. 4 is a schematic diagram of an example transaction network according to one or more aspects described herein.

FIG. 4A is a flowchart further illustrating the method from FIG. 2, according to some embodiments of the present disclosure.

FIG. 5 illustrates an embodiment of an exemplary system architecture for the stablecoin blockchain system and a stablecoin according to one or more aspects described herein.

FIG. 5A is a block diagram illustrating one or more instructions, according to some embodiments of the present disclosure.

FIG. 6 is a schematic diagram of an Accelerator Store transaction network according to one or more aspects described herein.

### DETAILED DESCRIPTION

In the following description of various examples of the present invention, reference is made to the accompanying drawings, which form a part hereof, and in which are shown by way of illustration various example structures, systems, and steps in which aspects of the present invention may be practiced. It is to be understood that other specific arrangements of parts, structures, example devices, systems, and steps may be utilized, and structural and functional modifications may be made without departing from the scope of the present invention.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, solid state drives, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

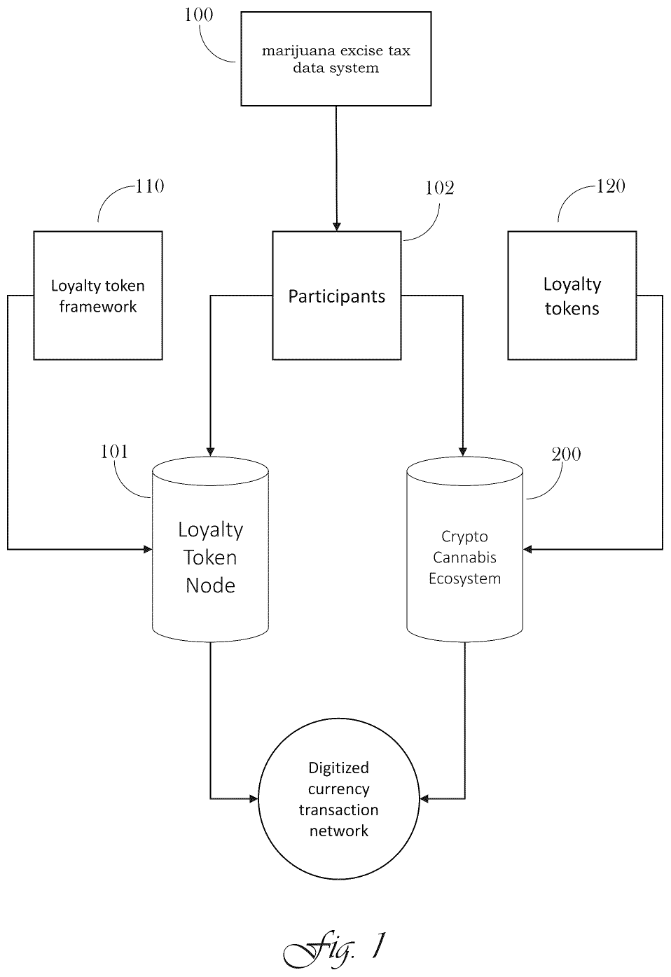

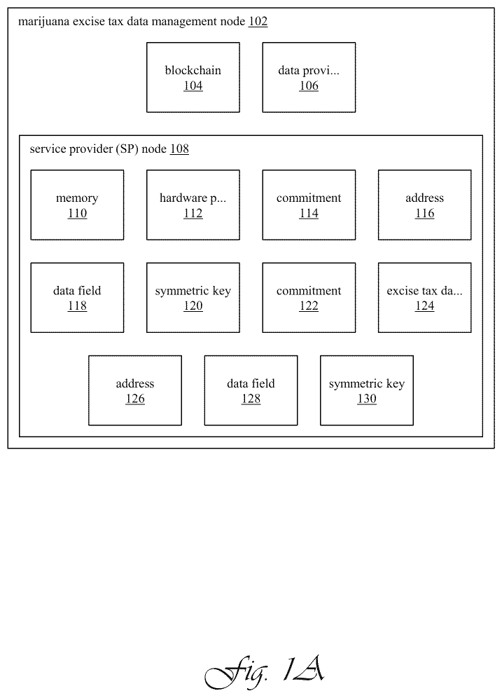

Various aspects described herein reference the regulated marijuana industry. FIG. 1 illustrates a marijuana excise tax data management node 100 with a blockchain loyalty token framework 110, a crypto cannabis ecosystem 200, and a digitized currency transaction network 400 in accordance with aspects of this present invention. As illustrated in FIG. 1, the marijuana excise tax data management node 100 facilitates transactions between blockchain loyalty token participants 102. The blockchain loyalty token participants 102 communicates with, and may operated a blockchain digitized currency node 101. Additionally, the loyalty token framework 110 may be used to construct one or more digitized currency nodes 101. The blockchain loyalty token participants 102 may combine as individuals to form a crypto cannabis ecosystem 200. The digital token node 101 connects nodes together in a digitized currency transaction network 400. Lastly, the crypto cannabis ecosystem 200 conducts transactions across the digitized currency transaction network 400.

There are a litany of very important issues plaguing the regulated marijuana industry at the time of this application, however the present invention addresses the following major concerns; (1) an overwhelming reliance on cash as a transaction medium which in turn undermines regulatory oversight mechanisms to accurately impose excise taxes on marijuana transactions; and (2) exposure of underage youth to marijuana marketing. The marijuana excise tax data management node 100 and the loyalty token framework 110 and related digitized currency technology can help solve both of these issues. Specifically, the use of the loyalty tokens 120 can effectively and efficiently replace cash as the primary transaction medium within the regulated marijuana industry, and the transparency/trust created by the marijuana excise tax data management node 100 and the blockchain loyalty token framework 110 can help establish viable and sustainable medium of value transfer for industry participants. Additionally, the marijuana excise tax data management node 100 and the blockchain loyalty token framework 110 provide a blockchain compliance and transparency solution to provide marijuana regulators 270 real time oversight mechanism for accurate tax imposition by authorities 250. Lastly, the present invention permits value transfer directly to the consumer 260 thus eliminating youth exposure to excess marijuana marketing materials.

A blockchain-based solution (i.e. like the loyalty token framework 110) is an ideal mechanism for creating transparency and fostering marijuana regulator trust of those marijuana industry stakeholders. Blockchain is a highly effective trust mechanism which, generally speaking, uses a cryptographically-secure shared ledger to irrefutably track complex transactions amongst many known parties. The key attributes of blockchain technology which make it an ideal solution are the following:

Continuous and Immutable Record: Blockchain technology, by its design, creates an ongoing record of all transactions (i.e. each a block) within the subject system. Additionally, blockchain technology ensures (via cryptography) that once a transaction has been entered into the ledger (i.e. the chain), and appropriately verified, such record can no longer be altered.

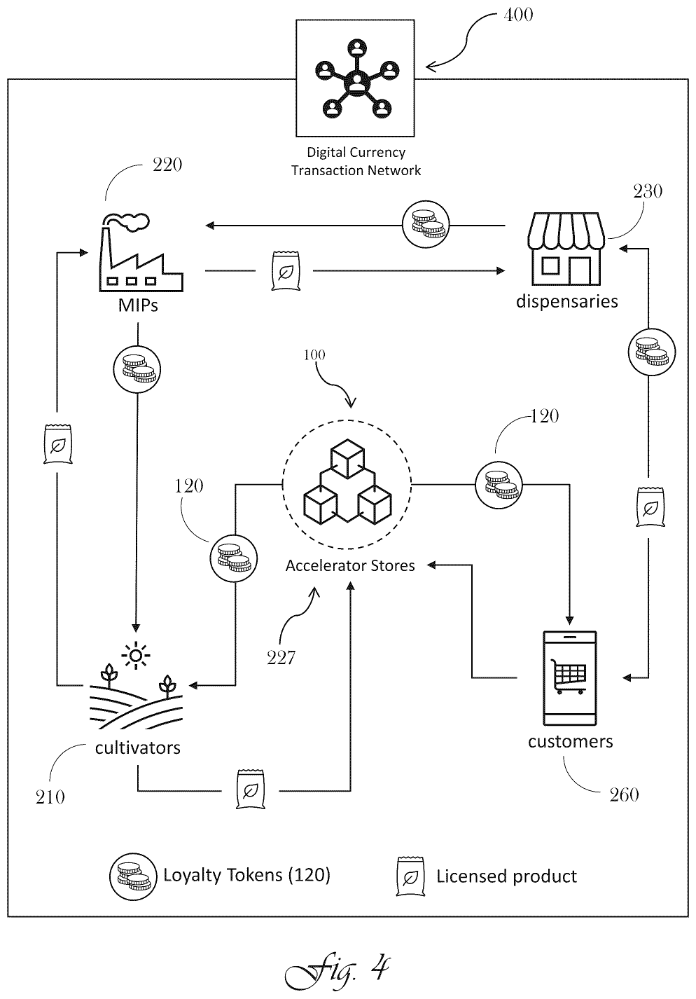

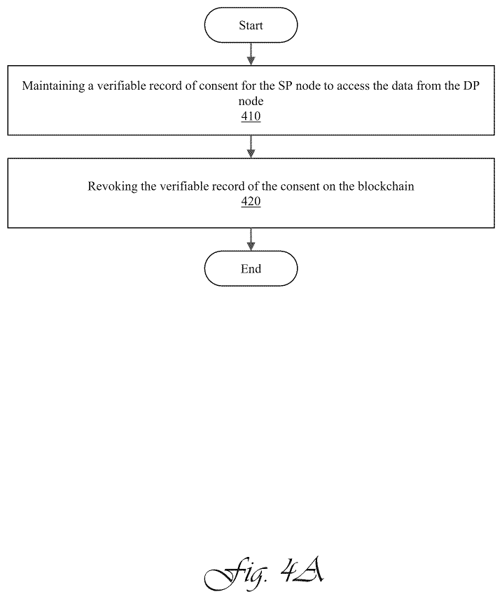

Full Transparency: A blockchain ledger, by its design, is held simultaneously, and requires validation, by certain sources within the system. Each transaction may require multi-party verification 320 before it can be entered into the ledger creating full transparency with respect to each transaction. Moreover, a blockchain ledger can be easily shared (in real-time) with outside regulators 270 and other parties to assist in satisfying compliance and related issues. FIG. 4 illustrates a graphical depiction of a two party, blockchain transaction.

Blockchain is rapidly becoming a world leading technology due its inherent ability to facilitate the assured exchange of value (in both digital and tangible assets) between parties, while simultaneously being able to protect their respective privacy and virtually eliminate fraud. Its relevance and applicability to regulating transactions within the regulated marijuana industry is similar to many other industry chain-of-custody applications currently moving toward blockchain based solutions; such as the pharmaceutical distribution and food production industries. The core benefits of all such commercial blockchain applications are generally the same; assuring the health and safety of consumers, preventing fraud and counterfeit transactions, and creating a transparent (while simultaneously privacy protected) record of transactions upon which interested parties (including especially marijuana regulators) can rely.

As described herein, a marijuana excise tax data management node 100 includes a blockchain-based, transaction framework 110 which is designed specifically to facilitate, to increase the transparency of, and to ease regulatory verification/oversight of, transactions within the regulatory marijuana industry. Further, the loyalty token framework 110 has the ability to capture, and maintain an immutable record of, all participant transactions; from seed to final sale. With the increased transaction transparency and trust which will be created by the use of the loyalty token framework 110. Equally, if not more importantly, for industry participants utilizing the blockchain loyalty token framework 110 all transactions will be facilitated with the use of the loyalty tokens 120. The use of loyalty tokens 120 may eliminate the need of such participants to transact in, and hold large sums of, cash. In fact, the loyalty tokens 120 may be utilized as a cash alternative within highly-regulated industries. The loyalty tokens 120 may replace cash as the primary means of facilitating regulated marijuana industry transactions.

In another embodiment of this invention, systems and methods in the regulated marijuana industry may use state authorized digital tokens, wherein the digital token may be authorized by a state securities commissioner or registered debt or equity, as a loyalty token 120 as a store of value and medium of exchange on a blockchain-based transaction network. The systems and methods may provide a novel process and way to transform marijuana excise tax savings into a tokenized transactional currency providing compliance and transparency. Additionally, the systems and methods may include chain of custody tracking for every transaction with blockchain loyalty token 120 throughout the process—from dispensary to final purchase. In another embodiment, the systems and methods may include further chain of custody tracking for every transaction with the blockchain loyalty token 120 throughout the process—from “seed-to-sale,” meaning from initial growing and planting of the seed to the final sale/purchase by the consumer and user of the cannabis. This chain of custody tracking may tie into product recalls and/or regulatory transactional auditing and tax imposition. The systems and methods may also include automated regulatory filings driven by the transaction log. Additionally, the systems and methods may create an automated auditing platform that includes auditing reports with the opportunity to partner with an auditing firm. The systems and methods may tie all of the supply chain components together under one financial transaction log and putting it all into an efficient tracking regime.

The methods and systems may include a means to provide a peer-to-peer methodology for conducting secure, auditable, marijuana transactions. The methods and systems provide a method of tracking assets and goods within the supply chain through the use of a blockchain loyalty token 120 as a medium of exchange in a digitized currency transaction network 400.

FIG. 1A is a block diagram that describes a marijuana excise tax data management node 1002, according to some embodiments of the present disclosure. In some embodiments, the marijuana excise tax data management node 1002 may include a blockchain 1004 and a data provider (DP) node 1006. The marijuana excise tax data management node 1002 may also include a service provider (SP) node 1008, the marijuana excise tax management node may be a computing device. The service provider (SP) node 1008 may include a memory 1010 storing one or more instructions, a hardware processor 1012 that when executing the one or more instructions may be configured to: a commitment 1014 to: an address 1016 of the DP node 1006, a data field 1018 of the DP node 1006, a symmetric key 1020 of the DP node 1006, a commitment 1022 to: an excise tax data field 1024 of the DP node 1006, an address 1026 of the DP node 1006, a data field 1028 of the DP node 1006, and a symmetric key 1030 of the DP node 1006.

In some embodiments, generate a profile token modelling a data profile of the DP node 1006. Generate a loyalty token modelling a data profile of the DP node 1006. Receive a transaction request from the SP node 1008 to access data from the DP node 1006 via the blockchain 1004, the blockchain network uses one or more smart contracts to manage transactions for multiple participating nodes. Acquire consent of the SP node 1008 based on the profile token. Acquire consent of the SP node 1008 based on the loyalty token. Generate a consent token based the consent of the SP node 1008. Allow the SP node 1008 to access the data of the DP node 1006 via the blockchain 1004 based on a zero-knowledge proof verification of the consent token.

In some embodiments, the processor 1012 may be further configured to: Maintain a verifiable record of consent for the SP node 1008 to access the data from the DP node 1006. In some embodiments, the processor 1012 may be further configured to: Execute the requested transaction if the verifiable record of the consent may exist on the blockchain 1004. In some embodiments, the verifiable record of the consent may be based on the zero-knowledge proof.

In some embodiments, the processor 1012 may be further configured to: Revoke the verifiable record of the consent on the blockchain 1004. Identities of consented parties may be not discoverable from the verifiable record of the consent. In some embodiments, the processor 1012 may be further configured to: Allow access to the data of the DP node 1006 by the SP node 1008. An identity of the DP node 1006 may be not discoverable. In some embodiments, the processor 1012 may be further configured to: Verify the consent token in a distributed manner based on consensus protocols.

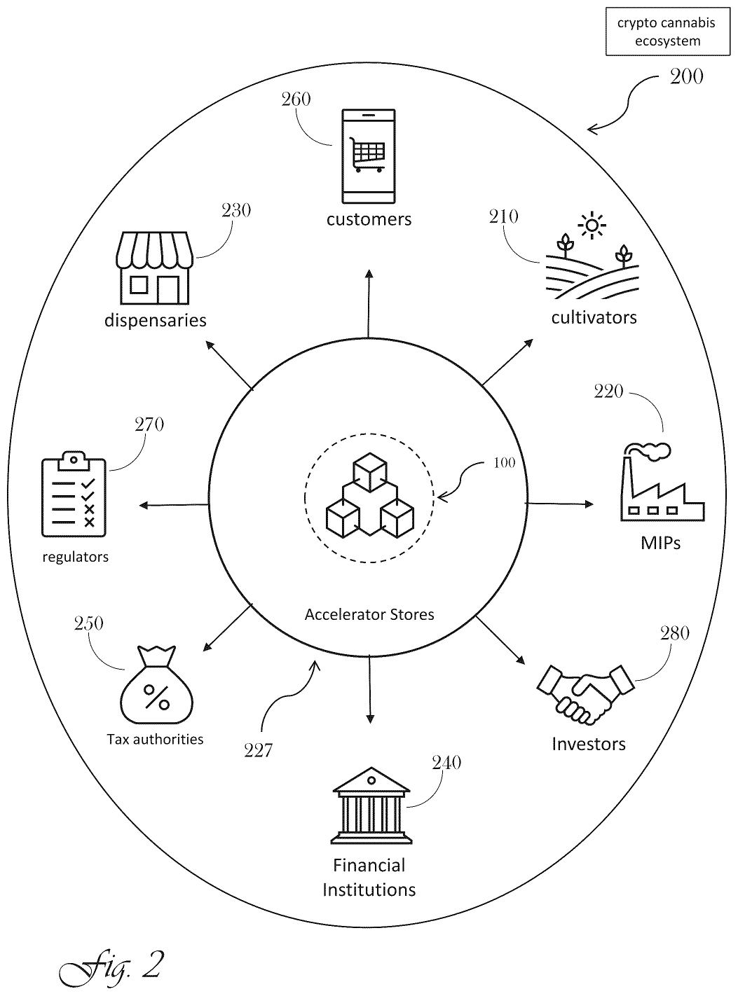

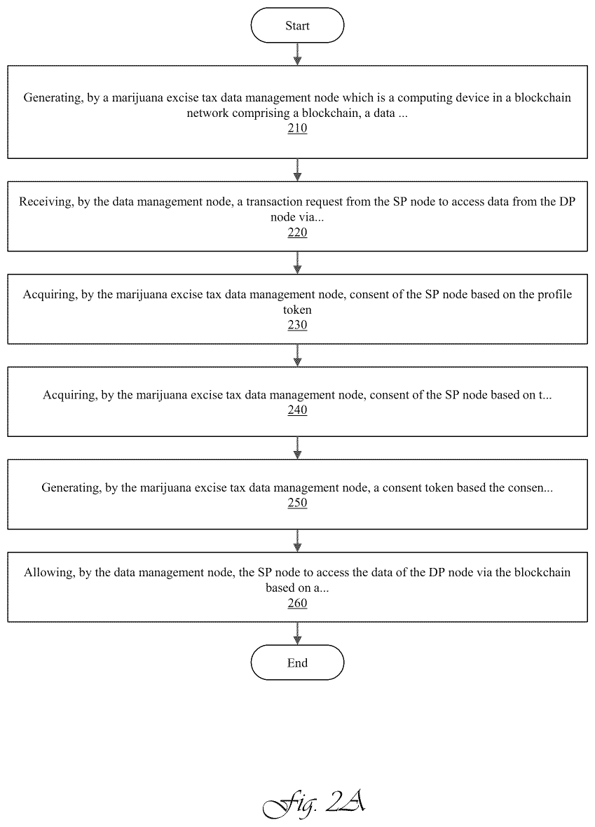

CRYPTO CANNABIS ECOSYSTEM. FIG. 2 illustrates a crypto cannabis ecosystem 200 as part of the marijuana excise tax data management node 100. As illustrated in FIG. 2, the crypto cannabis ecosystem 200 may include one or more of the following entities: medical and retail cultivators (or cultivators) 210, medical and retail marijuana infused processors (or MIPs) 220, social equity designated marijuana retailers (or Accelerator Stores) 227, medical or retail marijuana stores (or dispensaries) 230, Banks/credit unions 240, tax authorities 250, customers 260, regulators 270, and investors 280. More generally, the crypto cannabis ecosystem 200 may include: Producers, Processors, Consumers, Financial Agents, Regulatory Agents, and Tax Agents. The crypto cannabis ecosystem 200 may include other entities that participate in the transactions and financial systems of the various industries.

Cultivators 210: The marijuana excise tax data management node 100 may assist cultivators 210 with real-time marijuana excise tax data management node 100 may also produce and elicit trends of consumption through data analytics for the cultivators 210.

Marijuana infused processors (or MIPs) 220: The marijuana excise tax data management node 100 may assist MIPs 220 with real-time inventory management and improved projections of supply and demand. The marijuana excise tax data management node 100 may also produce and elicit trends of consumption through data analytics for the MIPs 220.

Accelerator Stores 227: The marijuana excise tax data management node 100 may reduce the transactional friction which exists with the U.S. Dollar because of conflicts between state and federal marijuana laws. The Accelerator Store 227 converts the value added by marijuana excise tax imposition exemption into a digitized currency, including but not limited to loyalty tokens 120 as a state authorized digital token and/or U.S. regulated security, that may reduce that transactional friction. The verification of loyalty token participants, facilitation of the loyalty tokens 120, management of the crypto cannabis ecosystem 200, and maintenance of the marijuana excise tax data management node 100 and loyalty token framework 110 is handled principally by the Accelerator Store 227. As an intermediary between regulators 270 and retail marijuana stores 230, the Accelerator Store 227 can facilitate accurate marijuana excise tax, and sales and use tax payments to authorities 250.

Dispensaries 230: Similar to the Accelerator Store 227, the marijuana excise tax data management node 100 may reduce the transactional friction which exists with the U.S. Dollar because of conflicts between state and federal marijuana laws. The loyalty token 120, as a state authorized digital token or SEC-regulated security, may reduce that transactional friction. The crypto cannabis ecosystem 200 and the marijuana excise tax data management node 100 can also assist dispensaries 230 and Accelerator Stores 227 by identifying supply/demand gaps and showing ways to mitigate those gaps, providing feedback mechanisms to cultivators 210 and MIPs 220, and use data to create predictive insights. Additionally, the loyalty token 120 may reduce the challenges of a primarily cash business. By lessening the amount of cash a dispensary 230 or Accelerator Store 227 receives, a more profitable and efficient transaction is created. The crypto cannabis ecosystem 200 as illustrated and described in this invention is the first ecosystem to bring together both a seed-to-sale decentralized ledger and a loyalty token 120 attached to that ledger.

Regulators 270: The marijuana excise tax data management node 100 may help government regulators 270 track transactions and take control of sourcing, selling, and pricing of products. The marijuana excise tax data management node 100 may also reduce or eliminate black market sales significantly and curb the frequency of back-channel deals.

FIG. 2A is a flowchart that describes a method, according to some embodiments of the present disclosure. In some embodiments, at 2010, the method may include generating, by a marijuana excise tax data management node which may be a computing device in a blockchain network comprising a blockchain, a data provider (DP) node, and a service provider (SP) node, a loyalty token based on a data profile of the DP node, the loyalty token modelling a data profile of the DP node, a profile token based on a data profile of the DP node, the profile token modelling a data profile of the DP node and comprising a commitment to:

In some embodiments, at 2020, the method may include receiving, by the data management node, a transaction request from the SP node to access data from the DP node via the blockchain, the blockchain network uses one or more smart contracts to manage transactions for multiple participating nodes. At 2030, the method may include acquiring, by the marijuana excise tax data management node, consent of the SP node based on the profile token.

In some embodiments, at 2040, the method may include acquiring, by the marijuana excise tax data management node, consent of the SP node based on the loyalty token. At 2050, the method may include generating, by the marijuana excise tax data management node, a consent token based the consent of the SP node. At 2060, the method may include allowing, by the data management node, the SP node to access the data of the DP node via the blockchain based on a zero-knowledge proof verification of the consent token. An address of the DP node. A data field of the DP node. A symmetric key of the DP node. In some embodiments, the method may include allowing access to the data from the DP node by the SP node. An identity of the DP node may be not discoverable. In some embodiments, the method may include verifying the consent token in a distributed manner based on consensus protocols.

FRAMEWORK. The marijuana excise tax data management node 100 will consist initially and primarily of maintenance of a blockchain-based, loyalty token transaction framework 110 which will utilize the loyalty tokens 120 to facilitate transactions related to, and to ease regulatory verification of, the growth, processing, and sale of regulated marijuana in the states/territories in which such sale is legal. The loyalty token blockchain framework 110 may be either a private blockchain or a public blockchain without departing from the system.

Loyalty tokens 120 may be cryptocurrencies or digital tokens that are designed to transform marijuana excise tax savings into a tokenized transactional currency. The blockchain loyalty token 120 may be a state authorized digital token or an SEC-regulated security as a store of value or a medium of exchange on the blockchain digitized currency transaction network 400. Additionally, the marijuana excise tax data management node 100 and the loyalty token framework 110 with related blockchain technology provides the following advantages: tax authorities 250 may be paid in real-time via the crypto cannabis ecosystem 200 and smart contracts; financial institutions 240 may provide mainstream banking services as the marijuana excise tax data management node 100 may reduce AML/KYC and other compliance costs; licensed marijuana operators will be able to access traditional banking services as all transactions will be tracked using the loyalty token 120 and financial institutions 240 can identify to the penny the origin of each and every transaction; State and Federal Regulators 270 may have unfettered transparency providing for easier compliance and regulatory oversight; and stablecoin users will receive dividend payment based on use of loyalty tokens 120.

In short, the loyalty token framework 110 operated by an Accelerator Store 227 and related digital token technology represent a unique, and truly viable, transaction solution to those operating in the regulated marijuana industry.

The marijuana excise tax data management node 100 includes a blockchain-based, loyalty token transaction framework 110, and related form of loyalty token or cryptocurrency 120, each of which will be identified by a unique identification number. The loyalty token framework 110 may be a private blockchain or a public blockchain without departing from this invention. The blockchain loyalty token framework 110 and the loyalty token 120 may facilitate transactions related to, and to ease regulatory verification of, the manufacture, distribution, and sale of regulated marijuana goods in states/territories, for example as the growth, processing, and sale of legal cannabis in the states/territories in which such sale is legal. Loyalty tokens 120 are, and will at all times be, digital assets.

The marijuana excise tax data management node 100 utilizes the blockchain cannabis loyalty token framework 110 to alleviate issues plaguing the regulated marijuana market by: (i) establishing a common transaction system or blockchain digitized currency transaction network 400 (and a common form of payment, i.e. the loyalty token 120) which industry providers and purchasers can use to facilitate transactions; and (ii) creating an immutable, auditable, ledger 305 of industry transactions which will ease transaction verification by regulators. In addition, the loyalty token framework 110 may allow for the creation and utilization of smart contract solutions between parties (e.g. Cultivators, MIPs, Consumers, Financial Agents, Regulatory Agents, or Tax Agents, etc.) which will permit the automatic recording and facilitating the exchange of goods, services, and private data as well as the automatic calculation, recording and payment of applicable taxes; and (iii) eliminate underage exposure to marijuana marketing.

Similar to other underlying cryptocurrency protocols, the marijuana excise tax data management node 100 is a blockchain-based ledger and payment processing system which will provide for a distributed, and immutable, record of participant activity by mandating consensus among a quorum of network participants to initiate/update transactions.

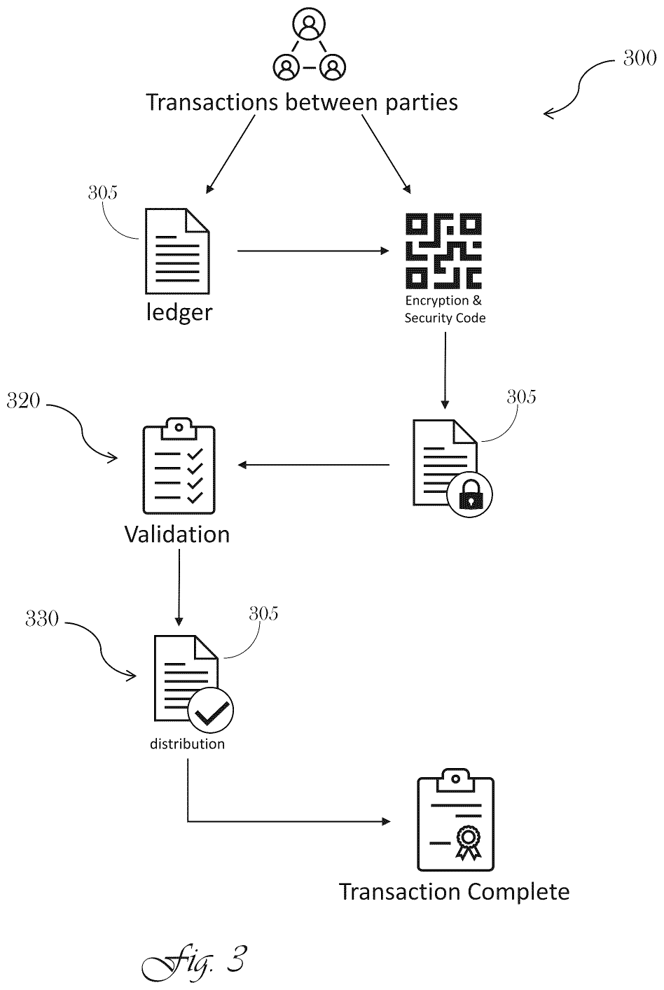

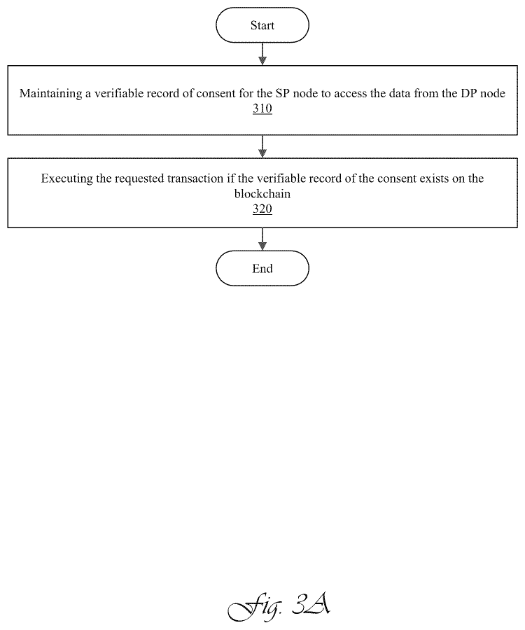

FIG. 3 illustrates a graphical depiction of a two-party blockchain transaction 300 on a ledger 305. As illustrated in FIG. 3, the two-party blockchain transaction 300 may include encryption 310, validation 320, and distribution 330. First, a transaction and agreement (smart contract) will occur between two parties. During encryption 310, the transaction may be added to an online transaction ledger 305 and encrypted with a digital security code 310. During validation 320, the code of the transaction may be sent to a large network where the authenticity of the code is confirmed without compromising private information and eliminating the need for a central authority for confirming transactions. Once the transaction is confirmed and validated by several parties, the transaction exists on the ledger 305 of each as a permanent and immutable record of the transaction. During distribution 330, the transaction information is recorded in a public ledger and the transaction is completed.

However, while the majority of cryptocurrencies in circulation today are sold/traded via a public infrastructure, in one embodiment of the invention, the blockchain loyalty token framework 110 may be a closed, and internally maintained, infrastructure. This means that only those persons that have established and maintain an account on the loyalty token framework 110, or who have otherwise been given special access (e.g. certain agents of governmental/regulatory bodies, as applicable), will be permitted to access the blockchain loyalty token framework 110 and/or any information made part of the underlying ledger 305. In another embodiment of the invention, the loyalty token framework 110 may be based on a public infrastructure as is used in a majority of blockchain framework systems.

As used herein, the blockchain loyalty token framework 110 may also include a set of core rules for, among other things: (i) establishing the underlying distributed ledger 305 making up the blockchain loyalty token framework 110; (ii) establishing the set of traceable data to be included in such distributed ledger 305; (iii) establishing the procedure for posting/validating 320 transactions to such distributed ledger 305; and (iv) establishing who will have access to the information provided in such distributed ledger 305.

The set of traceable data that may be tracked via the loyalty token framework 110 may include, but is not limited to: (1) marijuana excise tax saving converted into loyalty tokens; (2) the license information of all loyalty token framework 110 plant touching users 102 who are required to be licensed; and (3) the purchase/sale/transfer of each stablecoin transaction and all related goods and services, including for each such transaction: a record of the date/time/location of the subject transaction; a record of all purchasing/selling parties (including all applicable license information for each such party, if any); an invoice for all goods bought/sold/transferred (including specific identification of the types/quantity of such goods); a record of all taxes paid/payable in connection with the subject transaction; a record of any/all goods transporting parties as well as a real-time record of the initiation/completion of the respective transporting activities; and a real-time record of the current status of the subject transaction (e.g. initiated, in-transit, completed).

FIG. 3A is a flowchart that further describes the method from FIG. 2A, according to some embodiments of the present disclosure. In some embodiments, at 3010, the method may include maintaining a verifiable record of consent for the SP node to access the data from the DP node. In some embodiments, at 3020, the method may include executing the requested transaction if the verifiable record of the consent exists on the blockchain. In some embodiments, the verifiable record of the consent may be based on the zero-knowledge proof.

BLOCKCHAIN/LEDGER. The blockchain loyalty token framework 110 may be built on, and is an extension of, a loyalty token blockchain ledger protocol. The blockchain ledger protocol may update to the loyalty token framework 110 and the distributed ledger 305, which will require consensus from certain key participants 102 of the loyalty token framework 110. Each of those key participants 102 of the loyalty token framework 110 may operate one or more nodes 101 on the loyalty token framework 110. The loyalty token blockchain ledger protocol may include a modular architecture, which allows for dynamically adaptable validation and consensus rules; including the ability to simultaneously require both technical validation and legal validation for purposes of consensus. This allows the marijuana excise tax data management node 100 to create the complex set of validation protocols 320 necessary to facilitate the below mentioned automatic rejection capabilities. The loyalty token blockchain ledger protocol may also allow for the inclusion of outside audit capabilities on a separate, recorded, “chain” implemented as an outside audit channel. Such auditing outside users will be able to accesses some/all of the information provided in the underlying general ledger 305 while not being able to change/alter any such information in any way. This feature may be important to allow for review of some/all of the underlying transitional information by applicable overseeing governmental, banking and other regulating bodies.

In an example embodiment of the present invention, the validation protocol 320 utilized by the blockchain loyalty token framework 110 to vet updates/modifications to the loyalty token blockchain framework 110 and distributed ledger 305 may be a consensus algorithm/mechanism, or any other consensus algorithms that may be deployed as this technology matures. Additionally, to utilize the consensus algorithm/mechanism most effectively, the marijuana excise tax data management node 100 and the loyalty token framework 110 may be a closed, permission based, network. Validation protocols or other consensus algorithm/mechanism may be utilized by the loyalty token framework 110 to vet updates/modifications to the loyalty token framework 110 and the distributed ledger 305.

Accelerator Stores 227 in the blockchain loyalty token framework 110 will be the primary operators of the validation nodes 101 and will be the only ones with full access to the data on the blockchain loyalty token framework 110 and distributed ledger 305. The onboarding and selection of persons/entities who will be permitted to operate validation nodes within the framework 110 may be primarily based on the respective expertise/fiduciary responsibility/regulatory authority of the subject person/entity. Generally speaking, each of the following regulated parties will be eligible to participate as validating nodes 101 within the loyalty token framework 110: license marijuana operators, and governmental authorities/regulators.

The onboarding and selection of persons/entities who will operate validating nodes 101 within the blockchain loyalty token framework 110 may be added and may operate the sole validating node within the loyalty token framework 110. Further, any person/entity operating a validating node 101 within the loyalty token framework 110 may be removed. For the avoidance of doubt, no retail customer will be eligible to operating a validation node.

In addition to the foregoing, the blockchain loyalty token framework 110 may be hardcoded to automatically reject certain pre-determined prohibited transactions, including automatically rejecting any and all transactions where: the product/service purchaser is required pursuant to applicable law to be properly licensed and is not so licensed; the product/service purchaser is required to purchase products/services solely from a particular dispensary and the respective transaction is not being made at such location; the product/service seller is required pursuant to applicable law to be properly licensed and is not so licensed; and/or any product/service transporter involved in the respective transaction are required pursuant to applicable law to be properly licensed and are not so licensed.

Furthermore, according to other embodiments, blockchain technology, distributed ledger technology (DLT) 305, loyalty token/cryptocurrencies 120, and related developments have the potential to radically transform business process and financial transactions. Embodiments of this invention may include blockchain/DLT 305 advances to the legal cannabis industry or other highly-regulated industries. Through creation of a hybrid on-chain/off-chain model, the marijuana excise tax data management node 100 and distributed ledger technology 305 may provide a solution that addresses the most pressing banking, finance, and regulatory issues facing the market, while doing so in a way that is both cryptographically secure as well as highly performant.

Blockchain/Distributed Ledger Technology (DLT) Basics. A blockchain is a chain of blocks, each containing specific information. These blocks are interconnected and validated through consensus algorithms by network users. Data modifications are kept in subsequent blocks that link securely to prior ones. The primary goal of blockchain networks is data decentralization. Unlike traditional data storage, which relies on a central point and can fail, blockchain networks distribute data to all nodes. This prevents data loss from a single node and allows for data integrity checks via consensus algorithms. However, the degree of decentralization varies among different blockchain designs.

Permission levels in blockchain networks also vary. Some networks are permissionless, allowing any participant to join without prior approval. Conversely, some networks give a party control over node admission, effectively controlling the network. The more permission required to join, the higher the implicit trust in the nodes. In a blockchain without a central authority and unrestricted node addition or removal, managing the risk of bad data injection is a challenge. These risks are managed through basic blockchain mechanisms.

The blockchain digitized currency transaction network 400 of the present invention isn't fully decentralized, but it disperses control among participants. Their intrinsic motivation promotes good behavior, and the consensus mechanism allows for scaling the number of nodes based on participant agreement. Prospective nodes are verified to ensure their vested interest in the ecosystem.

Due to the complete data replication on each node, storage requirements increase with the number of nodes. Blockchains are not ideal for storing large, frequently changing data. The distributed ledgers 305 of the present invention track loyalty token ownership transfers, maintaining each token's complete trading history from issuance. Some portions of this ledger may be publicly accessible.

The present invention system initially holds private keys on behalf of loyalty token 120 holders, simplifying user experience. The system 100 provides recourse for lost private keys, and maintains a continuously updated loyalty token ledger 305, recording each holder's name, address, token holdings, token ID Numbers, and other essential data. This ledger 305 is kept in a secure format, and holders can access their account information. The system may also provide ledger data to regulatory or banking agencies if required.

TRANSACTION NETWORK. The marijuana excise tax data management node 100 includes a digitized currency transaction network 400, which offers an electronic purchase, loyalty and rewards, and payment platform for the regulated marijuana industry. As illustrated in FIG. 4, this network accelerates transaction speed and improves cost-effectiveness, benefiting consumers with product information and pricing transparency. The system uses loyalty token 120 to streamline transactions for licensed marijuana operators while supplying data and analytics.

Compliance Solution. The digitized currency transaction network 400 addresses banking issues in regulated industries by using loyalty token 120, a state authorized digital token and/or SEC-regulated exchange medium, and a blockchain-based ledger for seed-to-sale compliance and transparency.

Blockchain Infrastructure. FIG. 4 depicts a financial infrastructure tool using loyalty token 120 at its core. Each transaction posts to an immutable auditable ledger 305 containing key information for compliance with federal and state regulations, anti-money laundering rules and the US Patriot and Bank Secrecy Acts.

Transaction Process. The digitized currency transaction network 400 operates on the blockchain ledger 305. Customers 260 use cash to purchase cannabis products and earn loyalty tokens 120 from the Accelerator Store 227 via the digital marijuana excise tax data management node 100. Customers 260 then trade loyalty tokens 120 for products from dispensaries 230, which, in turn, exchange loyalty tokens 120 for products from MIPs 220. MIPs 220 then trade loyalty tokens 120 for raw materials from cultivators 210, who can exchange loyalty tokens 120 for cash with the marijuana excise tax data management node 100. Any participant 102 can trade their loyalty tokens 120 for cash with the system at any time.

Framework Account. As shown in FIG. 4, loyalty token earners need to open an account on the loyalty and rewards platform 100 for cash deposits and receiving payments, and on the blockchain loyalty token framework 110. The loyalty and rewards platform 100 allows real-time viewing of held loyalty tokens 120, changing account information, and transferring loyalty tokens 120. Account establishment requires fulfilling all required verifications by the blockchain marijuana excise tax data management node 100 and loyalty token framework 110.

Final Purchasing and Advantages. Primarily, customers 260 can purchased or earn loyalty tokens 120 primarily at Accelerator Stores 227 or dispensaries 230 via the loyalty and rewards platform or point-of-sale (POS) systems. The digital currency transaction network 400 offers several advantages: it enables real-time tax payments, eliminates unintended marijuana marketing to minors, streamlines financial institutions' AML/KYC compliance, provides operators with banking services and real-time data for audit and compliance, and offers regulators transparency into seed-to-sale operations, aiding oversight and regulation.

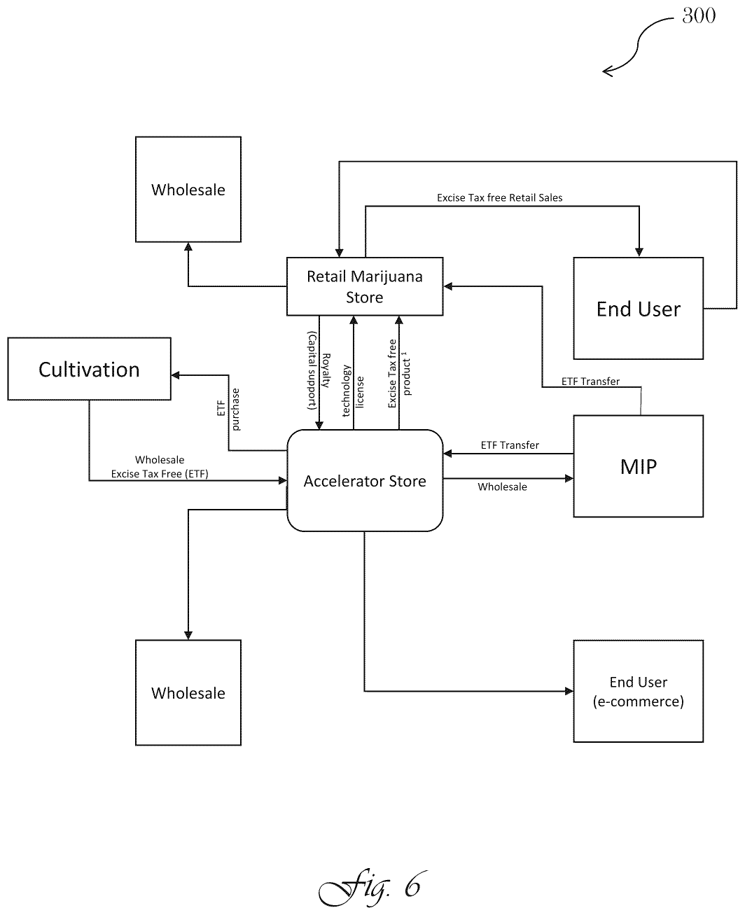

Onboarding. In the onboarding process for the blockchain marijuana excise tax data management node 100, shown in FIGS. 1-6, a customer account is created with customer information. The account details are then sent to the loyalty token blockchain ledger 305. This information is forwarded from the blockchain ledger 305 and undergoes a series of verification steps 320. Once the new customer account is confirmed, the data is accounted for in the blockchain marijuana excise tax data management node 100 and ledger 305. After confirmation, the marijuana excise tax data management node 100 conducts a pre-validation certification for the signature guarantee, facilitating the transfer of loyalty tokens 120. Entities from the crypto cannabis ecosystem 200 can also onboard using a similar process.

Required Customer Information. Prior to opening an account, the marijuana excise tax data management node 100 may collect any the following information for all accounts, if applicable, for any person, entity or organization that is opening a new account and whose name is on the account: (1) the name; (2) date of birth (for an individual); (3) an address, which will be a residential or business street address (for an individual) or a principal place of business, local office, or other physical location (for a person other than an individual); (4) an identification number, which will be a taxpayer identification number (for U.S. persons), or one or more of the following: a taxpayer identification number, passport number and country of issuance, alien identification card number, or number and country of issuance of any other government-issued document evidencing nationality or residence and bearing a photograph or other similar safeguard (for non-U.S. persons).

The marijuana excise tax data management node 100 may also perform one or more of the following: (1) Verify with the appropriate state authorities whether the business is duly licensed and registered; (2) Review the license application (and related documentation) submitted by the customer for obtaining a state license to operate the marijuana business; (3) Request from state licensing and enforcement authorities available information about the customer and related parties; (4) Develop an understanding of the normal and expected activity for the customer, including the types of products to be sold and the type of customers to be serviced (e.g. medical versus recreational customers); (5) Determine whether an marijuana business implicates one of the Cole Memo priorities or violates state law; (6) Monitor publicly available sources for adverse information about the customer and related parties; and/or (7) Refresh information obtained initially, on a periodic basis and commensurate with risk.

AUDITING/TAXES. Additionally, the methods and systems of the present invention will help provide regulators 270 with granular oversight of tax payments, in particular. The methods and systems of the present invention may help stop money laundering and other illicit payments in the market and may provide automated auditing reports for all transactions within the system.

The methods and systems of the present invention may help with capturing tax revenue in the regulated marijuana industry. The cash flux nature of the marijuana industry difficulties for regulators 270 and tax authorities 250 to accurately account transaction for tax imposition. The systems and methods, using the marijuana excise tax data management node 100, the loyalty token framework 110, and the blockchain distributed ledger 305, according to this invention, may track all transactions, and therefore create automatic payments for taxes to the regulators 270 and tax authorities 250 or IRS from the supply chain.

Additionally, the loyalty token 120 may allow for real-time remittance of all taxes and fees while providing real-time data and analytics to all interested and authorized users. Because the loyalty token 120 is an authorized digital token, it can easily be used for universal transactions.

Additionally, the marijuana excise tax data management node 100 and the blockchain loyalty token framework 110 with related blockchain technology may provide financial institutions with mainstream banking services as the marijuana excise tax data management node 100 reduces AML/KYC and other compliance costs. Additionally, cannabis operators will be able to access traditional banking services as all transactions will be tracked using the loyalty token 120 and banks can identify to the penny the origin of each and every transaction. Lastly, state and federal regulators may have unfettered transparency providing for easier compliance and regulatory oversight.

FIG. 4A is a flowchart that further describes the method from FIG. 2A, according to some embodiments of the present disclosure. In some embodiments, at 3010, the method may include maintaining a verifiable record of consent for the SP node to access the data from the DP node. In some embodiments, at 4020, the method may include revoking the verifiable record of the consent on the blockchain. Identities of consented parties may be not discoverable from the verifiable record of the consent.

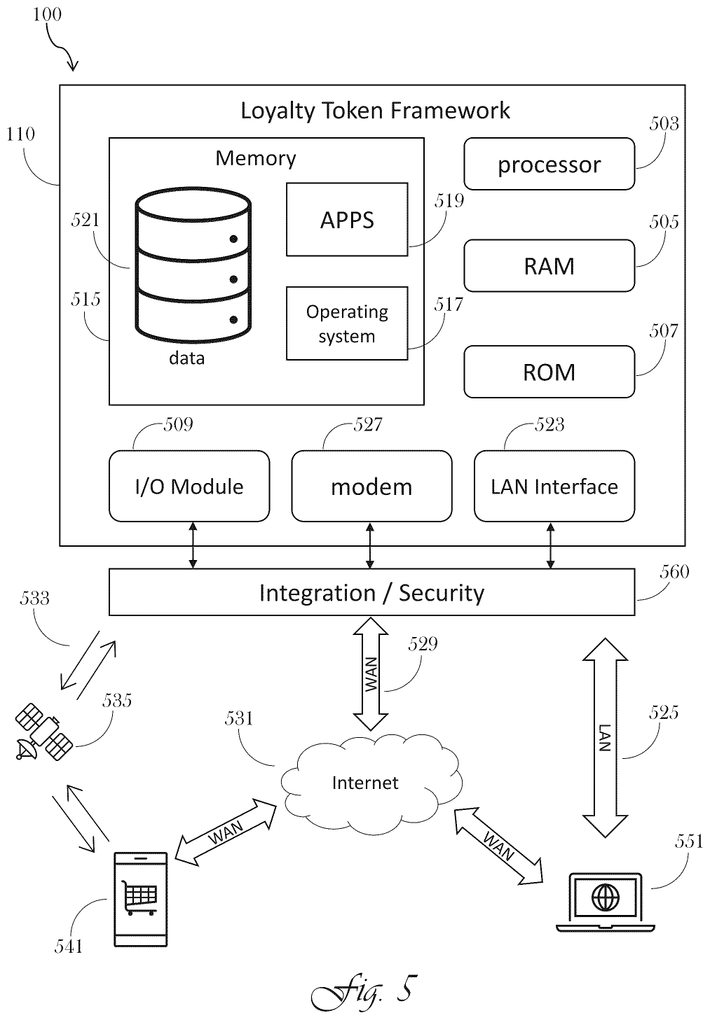

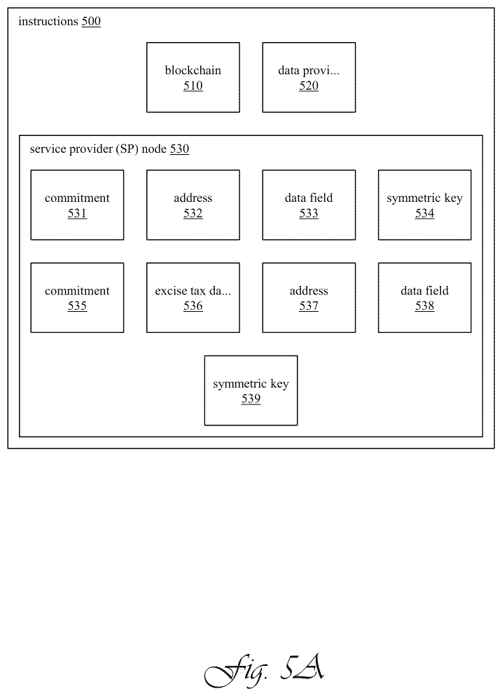

SYSTEM ARCHITECTURE. {FIG. 5} As will be appreciated by one of ordinary skill in the art upon reading the following disclosure, various aspects described herein may be embodied as a method, a computer system, or a computer program product, and specifically the blockchain loyalty token system 100 and the blockchain loyalty token framework 110. Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 5 illustrates a block diagram of the blockchain loyalty token framework 110 in the marijuana excise tax data management node 100 that may be used according to one or more illustrative embodiments of the disclosure. The marijuana excise tax data management node 100 and the blockchain loyalty token framework 110 may be a specially configured computing device and may have one or more processors 503 for controlling overall operation of the marijuana excise tax data management node 100 and its associated components, including one or more memory units (e.g., RAM 505, ROM 507), an input/output module 509, and a memory 515.

The input/output (I/O) module 509 may include one or more user interfaces, such as a camera, microphone, keypad, touch screen, and/or stylus through which a user of the marijuana excise tax data management node 100 and the blockchain loyalty token framework 110 may provide input, and may also include one or more of a speaker for providing audio output and a video display device for providing textual, audiovisual and/or graphical output. Software may be stored within memory 515 and/or storage to provide instructions to processor 503 for enabling a marijuana excise tax data management node 100 and the blockchain loyalty token framework 110 to perform various actions. For example, memory 515 may store software used by the marijuana excise tax data management node 100 and the blockchain loyalty token framework 110, such as an operating system 517, application programs 319, and associated databases 521. The application program 519 may be utilized by consumers to perform stablecoin transactions as detailed above. The various hardware memory units in memory 515 may include volatile and nonvolatile, removable and non-removable media implemented in any method or technology for storage of information such as computer readable instructions, data structures, program modules or other data. The memory 515 also may include one or more physical persistent memory devices and/or one or more non-persistent memory devices. The memory 515 may include, but is not limited to, random access memory (RAM) 505, read only memory (ROM) 507, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the processor 503.

The processor 503 may include a single central processing unit (CPU), which may be a single-core or multi-core processor (e.g., dual-core, quad-core, etc.), or may include multiple CPUs. In some cases, the processor 503 may have various bit sizes (e.g., 16-bit, 32-bit, 64-bit, 96-bit, 128-bit, etc.) and various processor speeds (ranging from 100 MHz to 5 Ghz or faster). The processor 503 and its associated components may allow the marijuana excise tax data management node 100 and the blockchain loyalty token framework 110 to execute a series of computer-readable instructions, for example, for a loyalty token blockchain-based, transaction framework 110 designed to facilitate, to increase the transparency of, and to ease regulatory verification/oversight of, transactions within the regulated marijuana industry.

The marijuana excise tax data management node 100 and the blockchain loyalty token framework 110 (e.g., a user device, retailer device/server, processor device/server, and one or more server computers, etc.) may operate in a networked environment (e.g., the marijuana excise tax data management node 100) supporting connections to one or more remote computers, such as terminals 541 and 551. The terminals 541 and 551 may be personal computers, servers (e.g., web servers, database servers), clients, or mobile communication devices (e.g., mobile phones, portable computing devices, and the like), and may include some or all of the elements described above with respect to the marijuana excise tax data management node 100 and the blockchain loyalty token framework 110. In some cases, the terminals 541, 551 may be located at one or more different geographic locations. The network connections depicted in FIG. 5 include a local area network (LAN) 525 and a wide area network (WAN) 529, and a wireless telecommunications network 533, but may also include other networks. When used in a LAN networking environment, the marijuana excise tax data management node 100 and the blockchain loyalty token framework 110 may be connected to the LAN 525 through a network interface or adapter 523. When used in a WAN networking environment, the marijuana excise tax data management node 100 and the blockchain loyalty token framework 110 may include a modem 527 or other means for establishing communications over the WAN 529, such as network 531 (e.g., the Internet, a cellular network, and the like). When used in a wireless telecommunications network 533, the marijuana excise tax data management node 100 and the blockchain loyalty token framework 110 may include one or more transceivers, digital signal processors, and additional circuitry and software for communicating with wireless computing devices 541 (e.g., mobile phones, portable customer computing devices) via one or more network devices 535 (e.g., base transceiver stations) in the wireless telecommunications network 533.

Also illustrated in FIG. 5 is a security and integration layer 560, through which communications may be sent and managed between the marijuana excise tax data management node 100 and the blockchain loyalty token framework 110 and the remote devices (terminals 541 and 551) and remote networks (networks 525, 529, and 533). The security and integration layer 560 may comprise one or more computing devices, such as web servers, authentication servers, and various networking components (e.g., firewalls, routers, gateways, load balancers, etc.), having some or all of the elements described above with respect to the marijuana excise tax data management node 100 and the blockchain loyalty token framework 110. As an example, security and integration layer 560 may comprise a set of web application servers configured to use secure protocols and to insulate the marijuana excise tax data management node 100 and the blockchain loyalty token framework 110 (e.g., one or more servers, a workstation, etc.) from external devices (e.g., terminals 541 and 551). In some cases, the security and integration layer 560 may correspond to a set of dedicated hardware and/or software operating at the same physical location and under the control of same entities as the marijuana excise tax data management node 100 and the blockchain loyalty token framework 110. For example, the integration layer 560 may correspond to one or more dedicated web servers and network hardware in a data center or in a cloud infrastructure supporting a cloud-based application and/or process. In other examples, the security and integration layer 560 may correspond to separate hardware and software components which may be operated at a separate physical location and/or by a separate entity.

In some cases, the data transferred to and from the marijuana excise tax data management node 100 and the blockchain loyalty token framework 110 may include secure and sensitive data, such as customer, retailer, processor, financial, etc. data. Therefore, it may be desirable to protect the data transmission by using secure network protocols and encryption, and also to protect the integrity of the data stored when on the marijuana excise tax data management node 100 and the blockchain loyalty token framework 110 using the security and integration layer 560 to authenticate users and restrict access to unknown or unauthorized users. In various implementations, security and integration layer 560 may provide, for example, a file-based integration scheme or a service-based integration scheme. In a filed-based integration scheme, data files may be transmitted to and from the marijuana excise tax data management node 100 and the blockchain loyalty token framework 110 through the security and integration layer 560, using various network communication protocols. Secure data transmission protocols and/or encryption may be used in file transfers to protect to integrity of the data, for example, File Transfer Protocol (FTP), Secure File Transfer Protocol (SFTP), and/or Pretty Good Privacy (PGP) encryption.

In service-based integration, one or more web services may be implemented between the marijuana excise tax data management node 100 and the blockchain loyalty token framework 110 and/or security and integration layer 560. The web services may be accessed by authorized external devices and users to support input, extraction, and manipulation of the data in the marijuana excise tax data management node 100 and the blockchain loyalty token framework 110. Web services built to support to the marijuana excise tax data management node 100 may be cross-domain and/or cross-platform, and may be built for enterprise use. Such web services may be developed in accordance with various web service standards, such as the Web Service Interoperability (WS-I) guidelines. In some examples, system web services may be implemented in the security and integration layer 560 using the Secure Sockets Layer (SSL) or Transport Layer Security (TLS) protocol to provide secure connections between the marijuana excise tax data management node 100 and the blockchain loyalty token framework 110 and various clients (e.g., terminals 541 and 551) attempting to access, insert and/or manipulate data within the marijuana excise tax data management node 100. SSL or TLS may use HTTP or HTTPS to provide authentication and/or confidentiality. In some cases, system web services may be implemented using the WS-Security standard, which provides for secure SOAP messages using XML encryption. In still other examples, the security and integration layer 560 may include specialized hardware for providing secure web services. For example, secure network appliances in the security and integration layer 560 may include built-in features such as hardware-accelerated SSL and HTTPS, WS-Security, and firewalls. Such specialized hardware may be installed and configured in the security and integration layer 560 in front of the web servers, so that any external devices may communicate directly with the specialized hardware.

Although not shown in FIG. 5, various elements within the memory 515 or other components in the marijuana excise tax data management node 100, may include one or more caches, for example, CPU caches used by the processing unit (e.g., the processor 503), page caches used by the operating system 517, disk caches of a hard drive, and/or database caches used to cache content from the database 521. For embodiments including a CPU cache, the CPU cache may be used by one or more processors in the processing unit (e.g., the processor 503) to reduce memory latency and access time. In such examples, a processor 503 may retrieve data from or write data to the CPU cache rather than reading/writing to memory 515, which may improve the speed of these operations. In some examples, a database cache may be created in which certain data from the database 521 may be cached in one or more separate smaller databases on an application server separate from the database server. For instance, in a multi-tiered application, a database cache on an application server can reduce data retrieval and data manipulation time by not needing to communicate over a network with a back-end database server. These types of caches and others may be included in various embodiments, and may provide potential advantages in certain implementations of the marijuana excise tax data management node 100 and the blockchain loyalty token framework 110.

It will be appreciated that the network connections shown are illustrative and other means of establishing a communications link between the computers may be used. The existence of any of various network protocols such as TCP/IP, Ethernet, FTP, HTTP and the like, and of various wireless communication technologies such as GSM, CDMA, WiFi, and WiMAX, is presumed, and the various computer devices and system components described herein may be configured to communicate using any of these network protocols or technologies.

Additionally, one or more application programs 519, such as a loyalty token transaction application, may be used by the marijuana excise tax data management node 100 and the loyalty token framework 110, including computer executable instructions for a loyalty token blockchain-based, transaction framework 110 designed to facilitate, to increase the transparency of, and to ease regulatory verification/oversight of, transactions within the regulated marijuana industry.

Aspects of the disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

FIG. 5A is a block diagram that describes one or more instructions 5000, according to some embodiments of the present disclosure. In some embodiments, a non-transitory computer readable medium. The one or more instructions 5000 may include a blockchain 5010 and a data provider (DP) node 5020. The one or more instructions 5000 may also include a service provider (SP) node 5030, cause the processor to perform: The service provider (SP) node 5030 may include a commitment 5031 to: an address 5032 of the DP node 5020, a data field 5033 of the DP node 5020, a symmetric key 5034 of the DP node 5020, a commitment 5035 to: an excise tax data field 5036 of the DP node 5020, an address 5037 of the DP node 5020, a data field 5038 of the DP node 5020, and a symmetric key 5039 of the DP node 5020.

In some embodiments, generating a profile token based on a data profile of the DP node 5020, the profile token modelling a data profile of the DP node 5020. Generate a loyalty token modelling a data profile of the DP node 5020. Receiving a transaction request from the SP node 5030 to access data from the DP node 5020 via the blockchain 5010, the blockchain network uses one or more smart contracts to manage transactions for multiple participating nodes.

In some embodiments, acquiring consent of the SP node 5030 based on the loyalty token. Generating a consent token based the consent of the SP node 5030. Allowing the SP node 5030 to access the data of the DP node 5020 via the blockchain 5010 based on a zero-knowledge proof verification of the consent token. Acquiring consent of the SP node 5030 based on the profile token. Generating a consent token based the consent of the SP node 5030. Allowing the SP node 5030 to access the data of the DP node 5020 via the blockchain 5010 based on a zero-knowledge proof verification of the consent token.

In some embodiments, the one or more instructions 5000 further cause the processor to perform. Maintaining a verifiable record of consent for the SP node 5030 to access the data from the DP node 5020. In some embodiments, the one or more instructions 5000 further cause the processor to perform. Executing the requested transaction if the verifiable record of the consent may exist on the blockchain 5010.

In some embodiments, the verifiable record of the consent may be based on the zero-knowledge proof. In some embodiments, the one or more instructions 5000 further cause the processor to perform. Revoking the verifiable record of the consent on the blockchain 5010. Identities of consented parties may be not discoverable from the verifiable record of the consent. In some embodiments, the one or more instructions 5000 further cause the processor to perform. Allowing access to the data from the DP node 5020 by the SP node 5030. An identity of the DP node 5020 may be not discoverable.

### Additional Considerations

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, e.g., as described in FIGS. 1-6. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein, e.g., with FIGS. 1-6, may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).

Some portions of this specification are presented in terms of algorithms or symbolic representations of operations on data stored as bits or binary digital signals within a machine memory (e.g., a computer memory, storage, or memory in FIG. 5). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, nonvolatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### CONCLUSION

The process discussed above is intended to be illustrative and not limiting. Persons skilled in the art could appreciate that steps of the process discussed herein can be omitted, modified, combined, or rearranged, and any additional steps can be performed without departing from the scope of the invention.

The inventions can be implemented by software, but can also be implemented in hardware or a combination of hardware and software. The invention can also be embodied as computer-readable code on a computer-readable medium. The computer-readable medium can include any data storage device that can store data which can thereafter be read by a computer system. Examples of the computer readable medium include read-only memory (“ROM”), random-access memory (“RAM”), CD-ROMs, DVDs, magnetic tape, optical data storage device, flash storage devices, or any other suitable storage devices. The computer readable medium can also be distributed over network coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of this disclosure. Therefore, obvious substitutions now or later known to one with ordinary skill in the art are defined to be within the scope of the defined elements.

While various embodiments have been described above, it should be understood that they have been presented by way of example only, and not limitation. For example, any of the elements associated with an marijuana excise tax system may employ any of the desired functionality set forth hereinabove. Thus, the breadth and scope of a preferred embodiment should not be limited.

Furthermore, the scope of the invention should be determined by the appended claims and their legal equivalents, rather than by the examples given.

What is claimed:

1. A marijuana excise tax data management node in a blockchain network comprising a blockchain, a data provider (DP) node, and a service provider (SP) node, the marijuana excise tax management node is a computing device comprising: a memory storing one or more instructions; and a hardware processor that when executing the one or more instructions is configured to:
generate a profile token modelling a data profile of the DP node and comprising a commitment to:
an address of the DP node,
a data field of the DP node, and
a symmetric key of the DP node;
generate a loyalty token modelling a data profile of the DP node and comprising a commitment to:
an excise tax data field of the DP node,
an address of the DP node,
a data field of the DP node, and
a symmetric key of the DP node;
receive a transaction request from the SP node to access data from the DP node via the blockchain, the blockchain network uses one or more smart contracts to manage transactions for multiple participating nodes;
acquire consent of the SP node based on the profile token,
acquire consent of the SP node based on the loyalty token;
generate a consent token based the consent of the SP node; and
allow the SP node to access the data of the DP node via the blockchain based on a zero-knowledge proof verification of the consent token.

2. The marijuana excise tax data management node of claim 1, wherein the processor is further configured to:
maintain a verifiable record of consent for the SP node to access the data from the DP node.

3. The marijuana excise tax data management node of claim 2, wherein the processor is further configured to:
execute the requested transaction if the verifiable record of the consent exists on the blockchain.

4. The marijuana excise tax data management node of claim 3, wherein the verifiable record of the consent is based on the zero-knowledge proof.

5. The marijuana excise tax data management node of claim 2, wherein the processor is further configured to:
revoke the verifiable record of the consent on the blockchain, wherein identities of consented parties are not discoverable from the verifiable record of the consent.

6. The marijuana excise tax data management node of claim 1, wherein the processor is further configured to:
allow access to the data of the DP node by the SP node, wherein an identity of the DP node is not discoverable.

7. The marijuana excise tax data management node of claim 1, wherein the processor is further configured to:
verify the consent token in a distributed manner based on consensus protocols.

8. A method, comprising:
generating, by a marijuana excise tax data management node which is a computing device in a blockchain network comprising a blockchain, a data provider (DP) node, and a service provider (SP) node, a loyalty token based on a data profile of the DP node, the loyalty token modelling a data profile of the DP node, a profile token based on a data profile of the DP node, the profile token modelling a data profile of the DP node and comprising a commitment to:
an address of the DP node,
a data field of the DP node, and
a symmetric key of the DP node;
receiving, by the marijuana excise tax data management node, a transaction request from the SP node to access data from the DP node via the blockchain, the blockchain network uses one or more smart contracts to manage transactions for multiple participating nodes;
acquiring, by the marijuana excise tax data management node, consent of the SP node based on the profile token;
acquiring, by the marijuana excise tax data management node, consent of the SP node based on the loyalty token;
generating, by the marijuana excise tax data management node, a consent token based the consent of the SP node; and allowing, by the data management node, the SP node to access the data of the DP node via the blockchain based on a zero-knowledge proof verification of the consent token.

9. The method of claim 8, further comprising:
maintaining a verifiable record of consent for the SP node to access the data from the DP node.

10. The method of claim 9, further comprising:
executing the requested transaction if the verifiable record of the consent exists on the blockchain.

11. The method of claim 10, wherein the verifiable record of the consent is based on the zero-knowledge proof.

12. The method of claim 9, further comprising:
revoking the verifiable record of the consent on the blockchain, wherein identities of consented parties are not discoverable from the verifiable record of the consent.

13. The method of claim 8, further comprising:
allowing access to the data from the DP node by the SP node, wherein an identity of the DP node is not discoverable.

14. The method of claim 8, further comprising:
verifying the consent token in a distributed manner based on consensus protocols.

15. A non-transitory computer readable medium comprising one or more instructions that when executed by a hardware processor of a marijuana excise tax data management node which is a computing device in a blockchain network comprising a blockchain, a data provider (DP) node, and a service provider (SP) node, cause the processor to perform:
generating a profile token based on a data profile of the DP node, the profile token modelling a data profile of the DP node and comprising a commitment to:
an address of the DP node,
a data field of the DP node, and
a symmetric key of the DP node;
generate a loyalty token modelling a data profile of the DP node and comprising a commitment to:
an excise tax data field of the DP node,
an address of the DP node,
a data field of the DP node, and
a symmetric key of the DP node;
receiving a transaction request from the SP node to access data from the DP node via the blockchain, the blockchain network uses one or more smart contracts to manage transactions for multiple participating nodes;
acquiring consent of the SP node based on the loyalty token; generating a consent token based the consent of the SP node; and allowing the SP node to access the data of the DP node via the blockchain based on a zero-knowledge proof verification of the consent token;
acquiring consent of the SP node based on the profile token; generating a consent token based the consent of the SP node; and allowing the SP node to access the data of the DP node via the blockchain based on a zero-knowledge proof verification of the consent token.

16. The non-transitory computer readable medium of claim 15, wherein the one or more instructions further cause the processor to perform:
maintaining a verifiable record of consent for the SP node to access the data from the DP node.

17. The non-transitory computer readable medium of claim 16, wherein the one or more instructions further cause the processor to perform:
executing the requested transaction if the verifiable record of the consent exists on the blockchain.

18. The non-transitory computer readable medium of claim 17, wherein the verifiable record of the consent is based on the zero-knowledge proof.

19. The non-transitory computer readable medium of claim 16, wherein the one or more instructions further cause the processor to perform:
revoking the verifiable record of the consent on the blockchain, wherein identities of consented parties are not discoverable from the verifiable record of the consent.

20. The non-transitory computer readable medium of claim 15, wherein the one or more instructions further cause the processor to perform:
allowing access to the data from the DP node by the SP node, wherein an identity of the DP node is not discoverable.
